(19) United States
(12) Patent Application Publication
(10) Pub. No.: US 2003/0187692 A1
(43) Pub. Date: Oct. 2, 2003

(54) Extended order communication system based on internet and method thereof

(76) Inventor: Yong-Nam Park, Seoul (KR)

Correspondence Address: Mathews Collins, Shepherd & McKay, Suite 306, 100 Thanet Circle, Princeton, NJ, 08540, US

(21) Appl. No.: 10/203,851

(22) PCT Filed: Feb. 14, 2001
(86) PCT No.: PCT/KR01/00221

(30) Foreign Application Priority Data
Feb. 15, 2000 (KR) 2000/6997

(51) Int. Cl. G06F 17/60

(52) U.S. Cl. 705/2

(57) ABSTRACT

An object of the present invention is to provide the electronic prescription system based on the internet and implementing method thereof which may rapidly and accurately transmit the prescription of patient treatment issued by doctor to pharmacist of pharmacy, and connect to the advertising system of pharmaceutical company. To accomplish the said objects, the present invention is characterised in that it comprises: the pharmacy database system (14); the group server (18) of the membership pharmaceutical; the Web server (10); the terminal computer group (KIOSK) for payment of medical examination, issuing and transmitting the electronic prescription according to the result of the medical treatment to the patient-designated pharmacy or the pharmacy in the close vicinity to residence over Internet after the medical treatment of patient; the pharmacy terminal; and the patient database system (16). By noticing that the request and management of such data is implemented in the server on the internet, and in authentication giving access admission, it is hard to identify patient himself, or in the medical characteristics, doctor and patient always has to meet each other, medical circles play a roll as authentication registration authority (RA) so as to give confirmation to patient identification, and the authenticated patient may have grant right about the designation of new family doctor on the Internet later.

### TECHNICAL FIELD

the medical information technology, messenger transmission technology, network technology, electronic authentication technology and internet related technology.

### BACKGROUND OF THE INVENTION

The present invention relates to the constitution of the role separation system of pharmacist and doctor in which doctor executes only medical treatment of patient and issues only prescription, and pharmacist executes only preparation and medication, and relates to, in case of giving effect to such a separation system, the electronic prescription system based on the Internet and implementing method thereof which may transmit the treatment prescription of patient issued by doctor to pharmacist of his custom pharmacy rapidly and exactly and may also make use of all medical information as a basis of statistical data of national health by making the said information into database.

Due to the execution of the role separation of pharmacist and doctor, doctor got to issue only prescription about medicine and pharmacist got to prepare and medicate according to the prescription about the medicine. This execution of pharmacist and doctor has an actually urgent problem to solve the standardizing problem of prescription document, document storing problem, geometrical and time limit problem according to the transmission of prescription, exact transmission problem of prescription contents, and management problem.

In order to execute the role separation of pharmacist and doctor successfully, the procedure of medical treatment and preparation should be easier and more convenient for doctor and pharmacist than that of conventional medical treatment and preparation. Thus, if the execution is performed with paper type prescription, rapidity, accuracy and reliability of medication according to the result of treatment may not be guaranteed, mutual and effective medical treatment and remedy between patient, doctor and pharmacist cannot be implemented.

Therefore, in the execution of pharmacist and doctor, it is required to accommodate the sudden change of social environment, and Internet is placed as a representative which may lead such change of social environment in the information age. Since Internet enables the task to be handled with real time, Internet may provide with rapidity and accuracy of the transmission procedure of prescription which emerges as big problem in the role separation of pharmacist and doctor. The constitution of the role separation system of pharmacist and doctor based on the Internet is required and thus making electronic document become also required, and such making electronic document enables doctor to identify patient and issue authentication and enables patient to authenticate for doctor to read his medical record later.

### DISCLOSURE OF THE INVENTION

An object of the present invention is to provide the electronic prescription system based on the Internet and implementing method thereof which may rapidly and accurately transmit the treatment prescription of patient issued by doctor to pharmacist of pharmacy, and also make use of all the medical information related to the medical treatment and medication as a basis of statistical data of the national health by making the said information into database, in case of executing the role separation of pharmacist and doctor, in which doctor implements only treatment of patient and issue only prescription, and pharmacist implements only preparation and medication according to the prescription of doctor.

Another object of the invention is to provide the electronic prescription system based on the Internet and its implementing method which may rationally supply the source of funds required to constitute the electronic prescription system based on the Internet.

And, another object of the invention is to provide the electronic prescription system based on the Internet and its implementing method which has the function to properly reconcile concerns between doctor and pharmacist in the execution of the role separation of pharmacist and doctor.

And, another object of the invention is to provide the electronic prescription system based on the Internet and its implementing method which enables to return profit directly or indirectly to doctor and pharmacist by consuming the advertisement naturally when doctor prescribes and pharmacist confirms the prescription according to the execution of the role separation of pharmacist and doctor, and also enables the advertiser to send the custom advertisement to the target consumer, so that satisfies both sides.

To accomplish the said objects, the present invention is characterized in that it comprises: pharmacy database system storing the geographical and inventory information of the membership pharmacy; group server of the membership pharmaceutical company supplying the said pharmacy with medicines and administering their inventory information as each pharmacy unit; Web server constituting the Internet site for issue and receipt of the electronic prescription on the Internet based on the information of the said pharmacy database system and the said group server of the pharmaceutical company; hospital terminal group issuing and transmitting the electronic prescription according to the result of the medical treatment to the patient-designating pharmacy or the pharmacy in the close vicinity to residence over Internet after the medical treatment of patient; the pharmacy terminal group confirming whether the electronic prescription with the corresponding pharmacy registered own number of patient is transmitted in the visit of the patient to the pharmacy, preparing and medicating the medicine according to the prescription order if the said prescription order is received, and transmitting the said medication information to the Web server; and the patient database system collecting the medication information of the said pharmacy terminal and the medical treatment information of hospital terminal group, and storing the general information of each patient.

### BRIEF DESCRIPTION OF THE DRAWINGS

FIG. 1 is the block diagram illustrating the system of the present invention.

FIG. 2 is the flow chart illustrating total implementing process of the electronic prescription system according to the present invention.

FIG. 3 is the flow chart illustrating the subroutine of prescription of doctor in the electronic prescription system according to the present invention.

FIG. 4 is the flow chart illustrating the subroutine of designation of custom pharmacy by patient in the electronic prescription system according to the present invention.

FIG. 5 is the flow chart illustrating the subroutine of designation of medication by pharmacist in the electronic prescription system according to the present invention.

FIG. 6 is the flow chart illustrating the subroutine of preparation and medication according to pre-settlement in the system of the present invention.

FIG. 7 is the block diagram of the system of the present invention.

FIG. 8 is the flow chart illustrating the procedure of making medical treatment and affair record into database according to the present invention.

FIG. 9 Is the flow chart illustrating the procedure of the medical treatment using the medical treatment and affair record, and of updating treatment information according to the present invention.

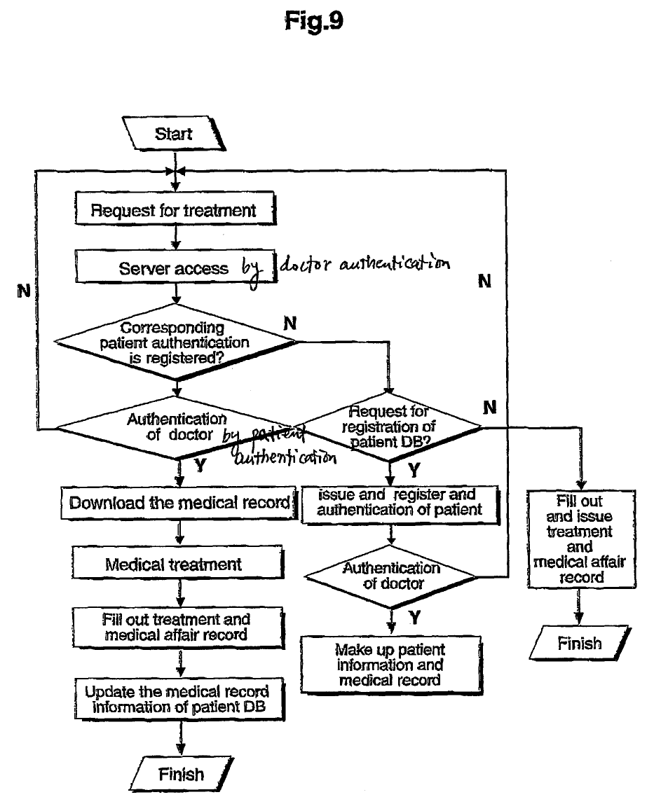

FIG. 10 is the flow chart illustrating the access to the medical treatment and affair record of patient.

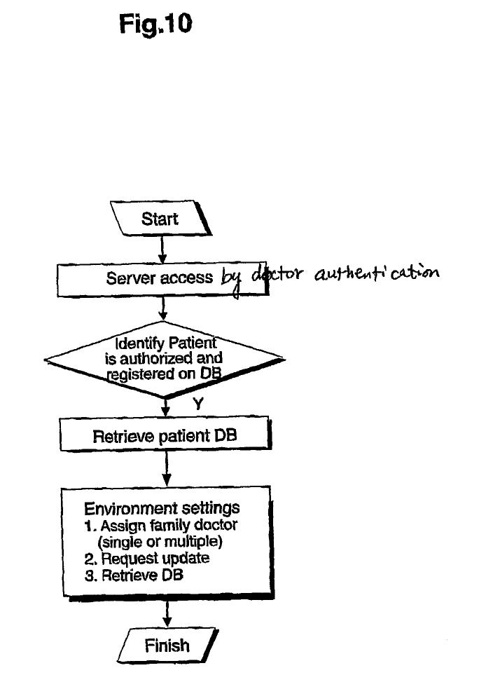

### DETAILED DESCRIPTION OF THE PREFERRED EMBODIMENTS

Referring to the attached drawing, the present invention may be explained more particularly as below.

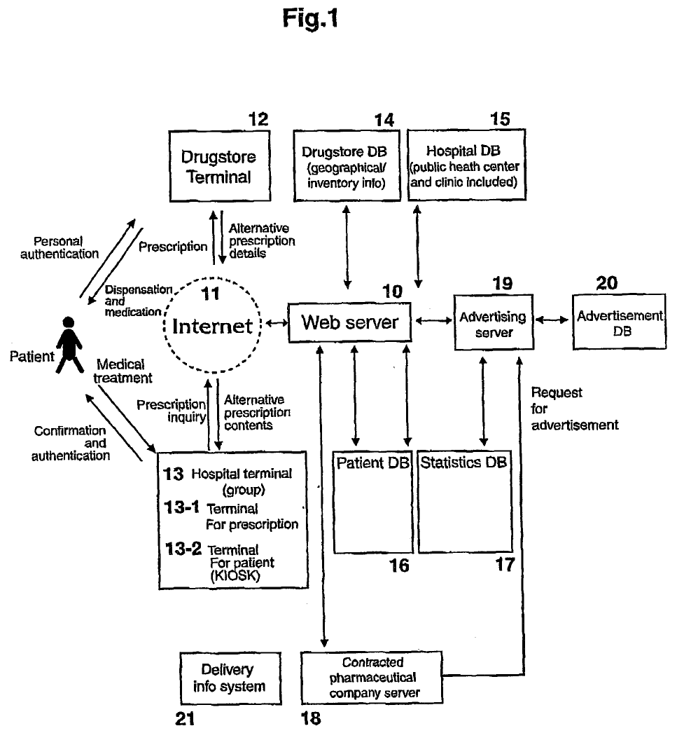

FIG. 1 is the block diagram illustrating the system of the present invention. As referred herein, the system of the invention includes Web server (10) constituting and administering homepage site for electronic prescription ordering on the Internet.

The electronic prescription ordering site administered by the Web site (10) may be connected with all the pharmacy terminals (12) and all the hospital terminals (13) of whole country, and due to the management of system, this site may endow these pharmacy and hospital terminals with specific identification numbers so as to actually access the electronic prescription ordering site with these numbers. These numbers can be email addresses for executing the role separation of pharmacist and doctor.

The said Web server (10) has pharmacy database (14) storing the geographical information and inventory information of each membership pharmacy through the country, a membership pharmaceutical company group server (18) for delivering medical supplies to the said membership pharmacies and managing the inventory information of each pharmacy as a unit, patient database (16) collecting the medication information of the said pharmacy terminal groups and treatment information of the said hospital terminal group so as to store information of each patent.

Also the said Web servers (10) can be connected with hospital database (15) for storing the information of each membership hospital of the country and statistical database (17) for managing and storing general information such as the decease information and medication information as personal, regional and age group, the said hospital database (15) can also include a health center and clinic as well as hospital.

Besides, the said Web server (10) may include an advertising server (19) for advertising custom advertisements in issuing electronic prescription by a doctor and confirming the prescription by a pharmacist and this advertising server may include advertisement database (20).

The said group server (18) of membership pharmaceutical company is constructed to be able to advertise its advertisements through the advertising server (19) and also this server can construct medical supply information processing system (21) to use as its own medical supply managing information with each pharmacy sharing the information related to compounding medicine and medication.

Said electronic prescription and medication process based on the system of the invention follows as below.

When doctor treats a visiting patient and then decides the suitable medication, doctor inputs the medication information of the corresponding patient connecting the electronic prescription site through hospital terminal (13). The input process of these medication information includes the followings: First, a doctor enters the keywords about a medical component and a kind of medicine decided by the doctor. Then a number of medical supplies related to the input condition will be shown as menu screen on the computer monitor.

A plenty of medicine on the computer monitor would be restricted by the membership pharmaceutical company's medical supplies and there is no information about medicine of the non-membership pharmaceutical company. It can be a method to attract many membership pharmaceutical companies early, by separating between company participating and not participating in construction of electronic prescription system of the invention.

When doctor makes up an electronic prescription and chooses a specific medicine among the plenty of medicines displayed on menu screen, advertisement of the pharmaceutical company which produce the corresponding medicine may be displayed. The commission fee of watching this advertisement is transferred automatically into the doctor's designated account. The forms of medicine advertisements may include line advertisements, flash advertisements, and full-page advertisements using various advertisement techniques.

After the determination of medication by doctor, patient determines his or her customary pharmacy or the nearest one of his or her residence Then doctor clicks the pharmacy database (14) through Web server (10) and checks the registration of membership of the designated pharmacy, transmits the electronic prescription through the unique number, and notifies the result to the patient. Unless the patient designates specific pharmacy, with operating the geographical information system served by Web server (10), the doctor searches the nearest membership pharmacy of the patient's, residence transmits the electronic prescription through the identification number of the corresponding pharmacy, and notifies the result to the patient.

Before issuing the electronic prescription, if there is a choice of customary pharmacy for Internet transmitting an electronic prescription from hospital terminal (13) and the input of membership pharmacy identification number which can be a kind of email, Web server (10) searches the pharmaceutical company group server (18) or pharmacy database (14) and checks the inventory status of medicine prescribed to the designated pharmacy. In this process the inventory of medicine for preparing leads to the next stage, transmitting of an electronic prescription. Otherwise, another pharmacy should be found in order to prepare medicine and medicate by the electronic prescription through the request of re-choice.

In the process of issuing this electronic prescription, the paying in advance with credit card or cash is requested to the pharmacy with the electronic prescription. This makes it possible to respond promptly to medication need by the electronic prescription of a patient visiting pharmacy.

A doctor's treatment and electronic prescription result is transmitted and stored on the patient database system (16). This can be used as a reference in prescribing and checking the patient's past treatment. The record of treatment and medication of all patients is stored on the hospital database system (15) and is used as a statistical material.

The electronic prescription of a doctor about the visiting patient is transmitted to the pharmacy terminal (12), which is assigned by a patient or the nearest one from patient's place. When the patient visiting to the pharmacy gives his or her information, the pharmacist connects the pharmacy terminal (12) to the Internet site, prepares medicine, and medicates by the patient's electronic prescription.

In the case of settlement in advance in issuing electronic prescription after treatment, the prescription information is immediately transmitted to the designated pharmacy for preparing medicine and medication. The pharmacy prepares the medicine in advance of a patients visiting to medicate.

Before medicating, the pharmacist has the duty, of identifying the patient accurately. When the content of the electronic prescription on pharmacy terminal (12) is considered as improper one, the right to substitutable prescription is given to the pharmacist. In this case, the content of the substitutable prescription must be uploaded on Web server (10).

When preparing medicine and medication at the membership pharmacy, the pre-settlement of commission leads to charge medicine fee to the medical insurance cooperation. Otherwise, the pharmacy gets fee by credit card or cash. The settlement on compounding medicine and medicating by the role separation of pharmacist and doctor can have management systemization through the cooperative integration of paying system among the credit card cooperation, medical insurance cooperation, doctor's association, and related organization.

The execution of the role separation of pharmacist and doctor by the system of the present invention can get the total information about the public health and disease information, medical information, and medicine-compounding information, etc. To utilize for the government's health policy to people through storing all information about a national health care, membership pharmacy's compounding medicine and medication, and treatment of membership hospital on statistic database (17) on Web server.

The said Web server (10) may be connected to the pharmaceutical company group server (18), the group of sponsoring the system construction, This makes it possible to get the information of medicine consumption status and inventory status by the unit of each pharmacy. This information is connected with the membership pharmaceutical company's material information processing system (21) to manage the inventory and make medical supplies to pharmacies more suitable.

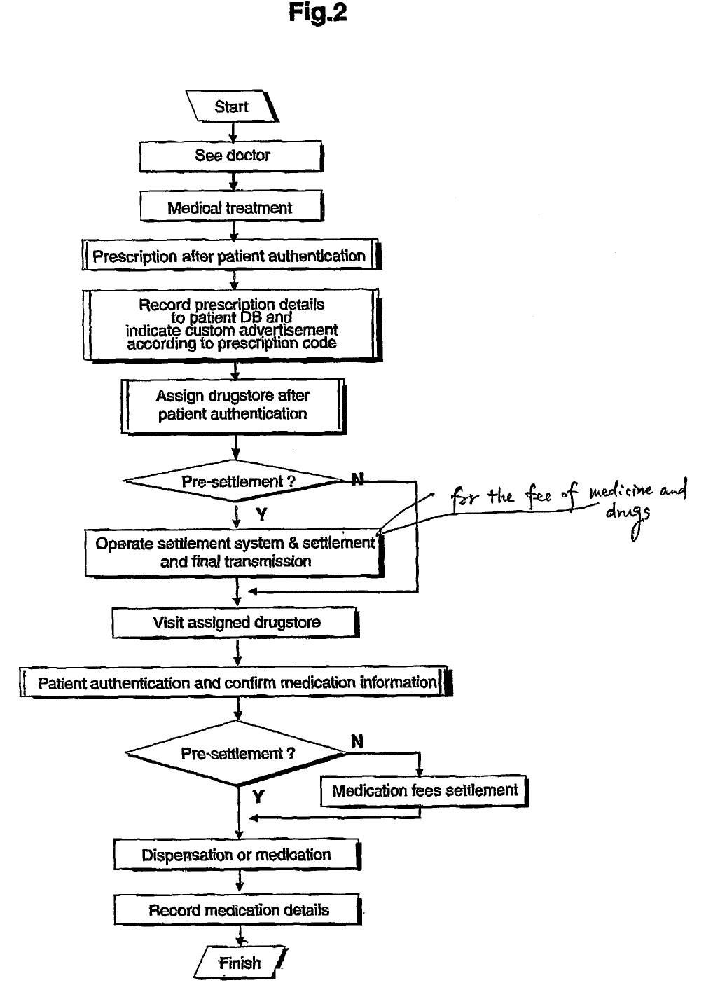

FIG. 2 is the flow chart of explanation of the total implementing process of electronic prescription system according to the invention.

As referred herein, when a patient visits and requests treatment, the doctor treats, identifies the patient, and makes up an electronic order. The electronic prescription is recorded on the patient database through web, updated, transmitted to the pharmacy which is designated or determined by the patient, and the pre-settlement is checked. If the patient guarantees the pre-settlement, the pre-settlement is executed through operation of paying system using direct paying card, pre-paid card, and credit card and the immediate medicine compounding order is transmitted to the pharmacy terminal.

After the process of identifying the patient visiting the pharmacy and checking the information of medication, the medicine compounding and medication are carried out by pre-settlement, and the money paying is carried out according to the pre-settlement way or post-settlement way. The medication information is recorded on the patient database through Web.

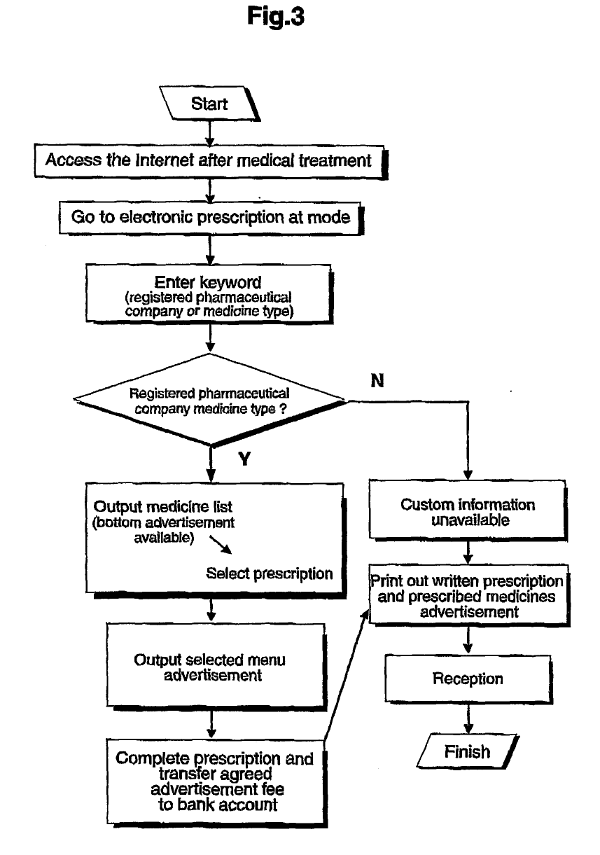

FIG. 3 is the flow of treatment subroutine in process of operating electronic prescription system.

After the hospital terminal's access to the Internet electronic prescription site in order to make an electronic prescription after treatment, with choosing the electronic prescription page and inputting the keyword related to the name of a pharmaceutical company or medication information, the list of sponsoring pharmaceutical company participating in electric order system construction and the medicine which the sponsoring company makes reveal. If the medicine recorded on the prescription is the product of non-membership pharmaceutical company not participating in electronic prescription system construction, electronic prescription system is impossibly is marked, the order content is output By the patient or in other ways, the prescription is transmitted to the designated pharmacy.

When the medicine by treatment is the product of membership pharmaceutical company participating in electronic prescription system construction, the product appears on the minor of hospital terminal or when every medicine of membership pharmaceutical company participating in electronic prescription construction related to the treatment appears on the monitor screen. The click of the specific medical product to medicate leads to the input of the product data into the treatment data. At the same time, the advertisement screen of the manufacturer, the company of the medicine is output. In other words, the menu of medicine product choice can also perform the role of the keyword for accessing the medicine advertisement page.

In the pharmaceutical company's position, this advertisement screen output makes the effect of the advertisement increasing owing to the high concentration on the advertisement to the consumer, a doctor.

The paying to the advertisement consumption returns to the doctor who decides the advertised medicine as the treatment medicine.

Especially, as the commercial has a type of customized advertisement of the potential customers, cost of the advertisement will be high. Though the doctor does not recognize profit making process directly while watching a monitor, he or she will have concern about income therefrom.

The side effect of the input of the prescription are accumulation of the database and time saving of patient's waiting for prescription which gives the doctor sense of obligation as a medical person and income from the advertisement will be used as a compensation fund at the cost of labor of the doctor.

The types of advertisement include banner located at the bottom of the monitor, pop-up image upon clicking, and flash image. The income of the doctor will be transferred to his or her account automatically in the form of cash or cyber point.

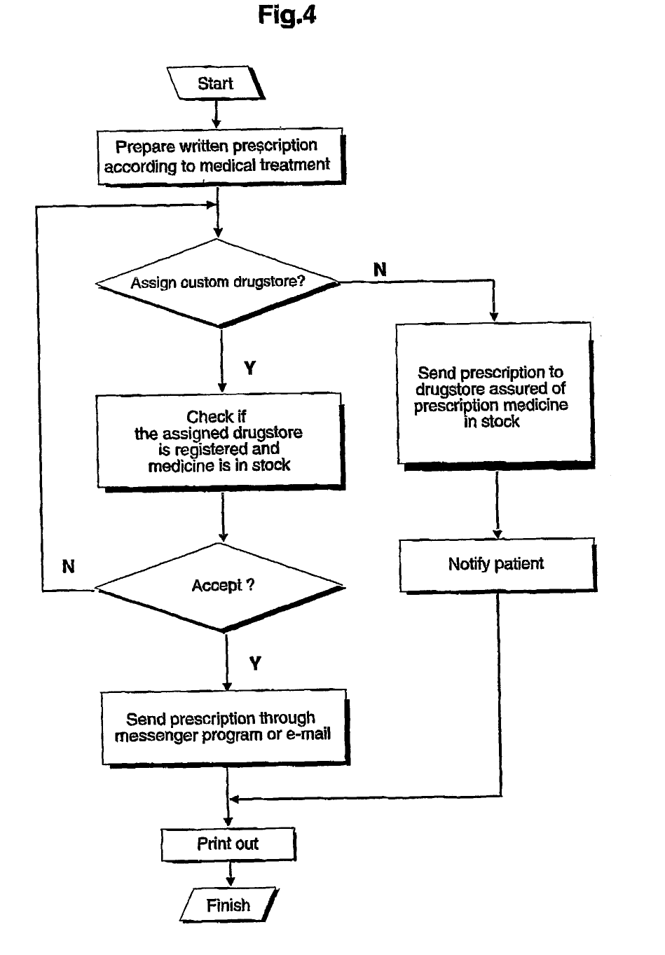

FIG. 4 shows the subroutine of the determination of the principal pharmacy in executing electronic prescription system.

After treatment, doctors input the prescription and electronic prescription system determines the favored pharmacy. When the patient has his or her favored pharmacy electronic prescription system inspects the several components: is the pharmacy registered at on electronic prescription system association; does the pharmacy have the prescribed medicines.

If the conditions are fulfilled, the electronic prescription system sends the prescription to the pharmacy (or the email address). Otherwise the electronic prescription system sends the prescription to the nearest pharmacy and after notifying patient about the fact the program will be terminated.

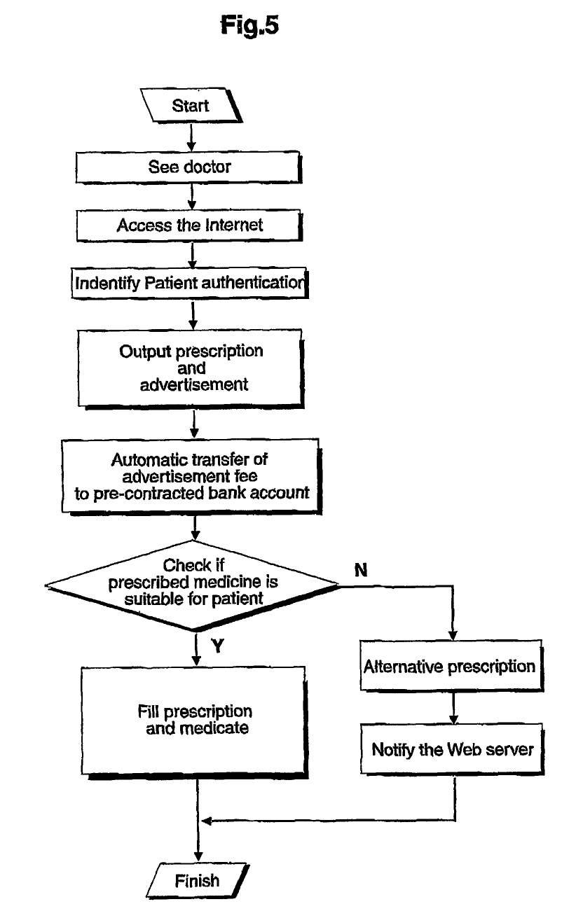

FIG. 5 explains the medication subroutine of electronic prescription system.

When the patient requests the prescription to the pharmacist, the pharmacist downloads the prescription inputted by the doctor after connecting the electronic prescription system Web site. After finishing the identification of the patient pharmacist make prescription to the patient in identifying process resident ID or order number can be used.

During the downloading, commercials will be appeared on the screen as at the case of doctors. The content of substitution prescription of the pharmacist will be transferred to the Web server. Cost of watching advertisement will be automatically transferred to the doctor's account.

In case that, in the confirmation of prescription order, alternative medicine is regarded to be more effective than the prescribed medicine, or the prescribed medicine is regarded not to be suitable, pharmacist can be implement alternative prescription according to his own judgment.

After the completion of alternative prescription, pharmacist may transmit the above situation to the Web server through the Internet site, and finish the task.

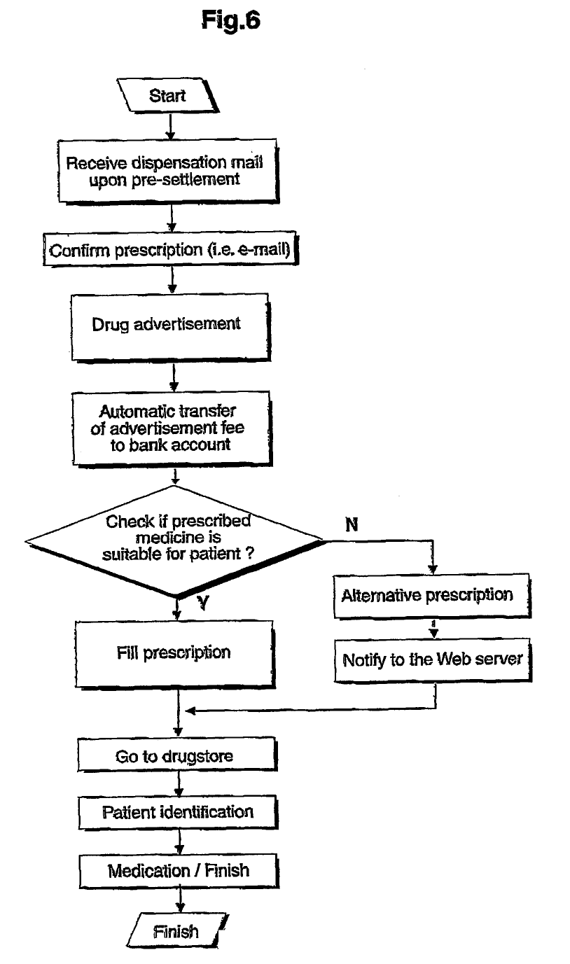

FIG. 6 is the flow chart illustrating the procedure of preparation and medication in case of the implementation of pre-settlement in the hospital.

Firstly, when the pre-settlement coincides with the issuing of prescription of doctor, the pre-settlement preparation mail may be sent to the terminal of the designated pharmacy. Then, pharmacist gets to open the email and confirm the prescription order, this time the advertisement of pharmaceutical company may be appeared in the same way of the time of issuing prescription by doctor. And the compensation (cash or cyber point) over the consumption of custom advertisement (viewing) may be transferred to the account contracted automatically.

Likewise, in case that, in the confirmation of prescription order, alternative medicine is regarded to be more effective than the prescribed medicine, or the prescribed medicine is regarded not to be suitable, pharmacist can be implement alternative prescription according to his own judgment.

After the completion of alternative prescription, pharmacist may transmit the above situation to the Web server through the Internet site. In pre-settlement, when patient visits after the completion of preparation in advance according to the electronic prescription, pharmacist refers his identity then implements medication, thereafter the task is finished.

All the prescription information on the Internet may be provided patient database system, statistical database system, pharmacy database system, hospital database system, and furthermore group server of pharmaceutical company, which are connected with the Web server, and may be used as statistical data.

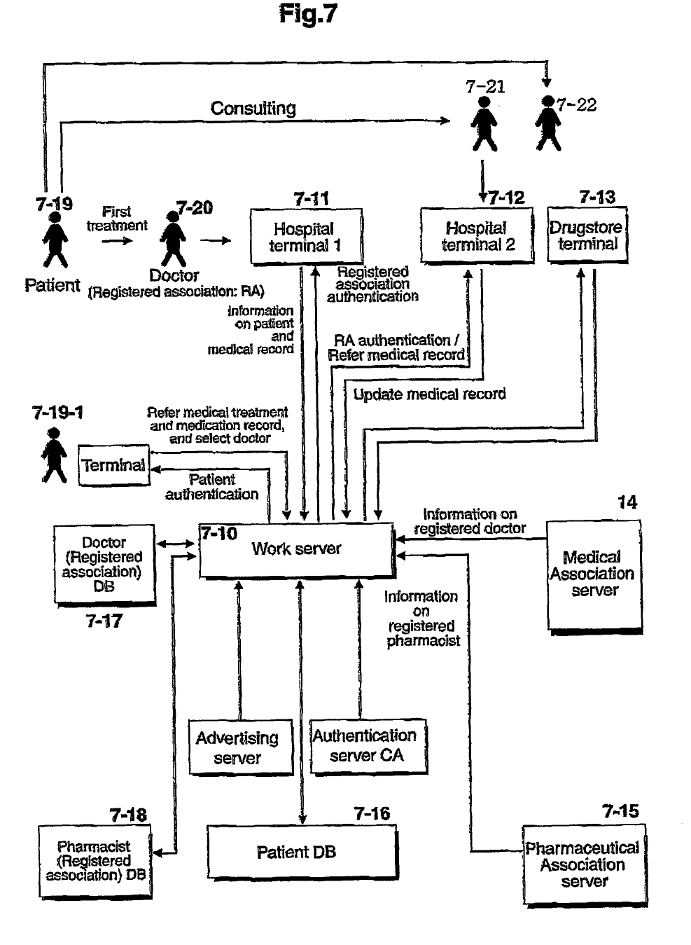

FIG. 7 is the block diagram illustrating the constituting system of the medical treatment and affair record database based on the Internet.

As referred herein, the system of the present invention may comprises the server (7-10) constituting and managing the homepage for electronic prescription ordering on the Internet.

The Internet site managed by this server (7-10) may be connected with all the hospital terminal (7-11, 12) and pharmacy terminal (7-13) of whole country, and then whenever needed, the treatment information of registered patient may be obtained form the said server (7-10) and the patient registration and renewal information of the treatment record may be updated.

The said server (7-10) may be connected with the patient database (7-16) storing the first or new medical treatment and affair record of specific patient transmitted from the above all pharmacy terminals (7-13) or hospital terminals (7-11, 12).

And, the said server (7-10) may be connected with medical association server (7-14) and pharmaceutical association server (7-15), and then tile registered doctor and pharmacist information provided from these associations may be downloaded, and such downloaded new pharmacist and doctor registration numbers are stored in each pharmacist database (7-18) and doctor database (7-17).

When patient (7-19) visits hospital and requests the medical treatment of doctor (7-20), doctor treats the patient and prescribes according to the result of the treatment.

The medication about the prescription may be implemented in the pharmacy according to the role separation of pharmacist and doctor.

At this time, since doctor has a duty to provide patient with the treatment record, in the request of the patient, doctor has to surely write out and provide with the medical treatment and affair record, and may transmit the patient record written down by doctor to the server (7-10) using hospital terminal (7-11) under the agreement of patient.

Before such transmission of the treatment record by doctor, the authentication over patient enables doctor to play a role of a registration authority.

The authentication of a patient is very important process to maintain genuineness and reliability of patient database.

Server (7-10) may be connected with medical association server (7-14) and pharmaceutical association server (7-15), and downloads the registered doctor and pharmacist information from each association and stores in each pharmacist database (7-18) and doctor database (7-17) of the server, and whenever each of doctor (7-20, 21) of hospital terminal (7-11, 12) or pharmacist (7-22) of pharmacy terminal (7-13) requests authentication as the registration authority, the server refers and authenticate.

Therefore, when the corresponding treatment doctor requests the authentication of registration authority in order to register the treatment record about the specific patient from hospital terminal (7-11), this authentication is referred and approved, and then doctor transmits the said record to server (7-10).

When the treatment record is inputted from hospital terminal (7-11), server (7-10) stores the record in patient database (7-16).

Patient database (7-16) is stored and managed individually, and after the first patient database is created, all the next treatment record or medication record is accumulatively recorded to the account of the membership patient.

Therefore, even though patient changes into other hospital or family doctor, new family doctor may read the past treatment record recorded to database of the patient using the corresponding hospital terminal (7-12) so that may avoid repeated treatment and examination.

Likewise, at this time doctor transmits the result of patient so that the disease history of patient may be administered continuously and systematically.

And, it is also allowed to refer to the past disease history or treatment result etc. of the visited patient using pharmacy terminal (7-13) in pharmacy, at this time the medication information is written out and uploaded by pharmacist of as registration authority.

Since the upload of the medication information by pharmacist and the treatment record by doctor burdens with duty or provides with certain economic value, early accomplishment of constituting aim of database of each patient may be promoted by compensation. And it may be used as statistic data of the public health.

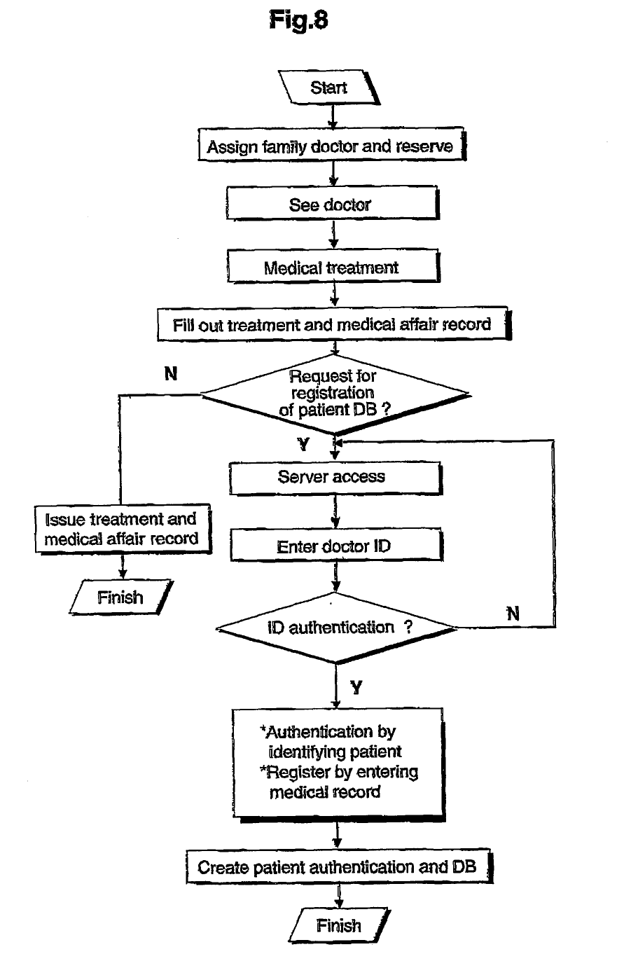

FIG. 8 is the flow chart illustrating the procedure of making patient database. As referred herein, when patient selects the family doctor and makes reservation through Internet etc., then visits hospital, the medical treatment is executed by the corresponding reserved family doctor. The doctor has to write out and provide the medical treatment and affair record to patient, but it is difficult for all patients to administer the record systematically. Therefore, the family doctor refers to whether the patient whom the doctor treats is registered to patient database, so that if the patient is registered, the doctor transmits the treatment record to patient database through the server, and if the patient is unregistered, doctor confirms whether the patient approves the registration to the patient database.

If the patient refuses to register to patient database, doctor writes out and issues the medical treatment and affair record and then his task is finished.

On the contrary, if the patient admits the registration to patient database, doctor connects hospital terminal to server through Internet and input the doctor's ID so that he obtains the authentication of as the registration authority, and then. transmits personal data and treatment record of the corresponding patient and creates and registers personal database to the membership patient database.

### BEST MODE FOR CARRYING OUT THE INVENTION

The invention enables to return profit directly or indirectly to doctor, pharmacist and patient by consuming the advertisement naturally when doctor prescribes and pharmacist confirms the prescription according to the execution of the role separation of pharmacist and doctor, and also enables the advertiser to send the custom advertisement to the target consumer, so that satisfies both sides.

In the execution of role separation of pharmacist and doctor, since the prescription order issued by doctor may be rapidly and accurately transmitted to pharmacist of pharmacy and use as foundation of statistical data of the national health by making all medical information related to the treatment and medication into database, the present invention is required to the active participation of hospital, pharmacy, patient and concerned industry, that is pharmaceutical company. The rational supply of funds is required to the constitution of the electronic prescription ordering system based on the Internet due to the benefit principle. Also, the invention has an effect on the execution of the national medical action in hospital and pharmacy by properly reconciling concerns between pharmacist, doctor and patient. In the burden of cost, since the part of prescription transmission may be eventually regarded as an effective sales network of medicine, it is desirable to lead and participate the cost burden of pharmaceutical company by use of pharmaceutical advertisement.

Industrial Availability

In the pharmacy, the present invention may be preferred positively because of the inconvenience of re-input of the paper prescription for insurance claim and thus the burden of personnel expense. The electronic purchasing method of medicine based on the prescription information can be applied to the corresponding industry. In case of patient, since patient can learn preparable pharmacy in advance, it is expected to the reduction of arrival time to the pharmacy and the reduction of wafting time after receipt of the prescription, so that the invention may be utilized positively and broadly.

What is claimed is:

1. The electronic prescription system based on the Internet comprising:
the drugstore database system (DB) (14) storing the geographical information and inventory information of the membership drugstore;
the group server (18) of the membership pharmaceutical company supplying the said drugstore with medicines and administering their inventory information as each drugstore unit;
the Web server (10) constituting the Internet site for receipt and transmission of the electronic prescription on the Internet based on the said drugstore database system (DB) and the said group server of the membership pharmaceutical company;
the self-service terminal group for patient (13-2) issuing and transmitting the paper and electronic prescription according to the result of the medical treatment to the patient-authorizing drugstore or the drugstore in the close vicinity to residence over the Internet, wherein doctor may input the prescription record to the patient treatment database (13-1) In the hospital after the treatment of patient and then the patient may reflect personal intentions about the selection of drugstore and may use the patient authentication, i.e. patient ID etc., in order to protect the persona( disease history of patient;
the drugstore terminal group (12) confirming whether the electronic prescription with the specific drugstore registered number of the patient is transmitted in the visit of the patient to the drugstore, making up and medicating the medicine according to the prescription information if the said prescription information is received, and transmitting the said medication information to the Web server; and
the patient database (DB) (16) collecting the medication information of the said-drugstore terminal and the medical treatment information of hospital terminal group, and storing the general information of each patient.

2. The electronic prescription system as defined in claim 1, wherein the said Web server (10) further includes the group server (18) of the pharmaceutical company for collecting the electronic prescription information of doctor through the hospital terminal and the medication information by the drugstore terminal, grasping the inventory information, communicating with delivery information processing system (21) so that mutual electronic order and product campaign are available by using the grasped drug inventory information of drugstore, and performing inventory control, electronic ordering and electronic payment.

3. The electronic prescription system as defined in claim 1 and 2, wherein the said Web server further includes the advertising statistical sever (19) which performs the electronic and the documentary (within the prescription) custom advertisement and custom medical information including the custom instructional information of taking medicine to an assigned doctor and an assigned pharmacist when writing out the electronic prescription and confirming the said prescription at the drugstore terminal, and to a patient when receiving and transmitting the prescription at the self-service terminal or the system assigned by patient according to the disease and drugs code of the prescription.

4. The electronic prescription system as defined in claim 1 wherein the said Web server further includes the statistics database system (DB) (17) which grasps the general information about the national health care, medical information and preparation information of the medicine etc. using the disease information of all patients, the preparation and medication information of membership drugstores, and the medical treatment information of membership hospitals through the electronic prescription according to the role separation of pharmacist and doctor.

5. A method of implementing the electronic prescription based on the Internet in performing the role separation of pharmacist and doctor comprising the steps of:
doctor inputting the electronic prescriptional data for patient according to the result of medical examination and treatment of patient visiting hospital into terminal computer;
doctor recording and updating the said electronic prescriptional data to the main patient database system (DB); patient paying the medical fee and assigning the said prescription to the drugstore using the digital key of pharmacist and the digital key of patent after indentifying self-authentication, and confirming whether the pre-settlement will be performed;
performing the pre-settlement using the settlement system when the patient approves the pre-settlement, printing out whether the settlement is performed, transmitting the electronic prescriptional data combined with payment information for instant preparation in the drugstore to the corresponding drugstore terminal, or transmitting only prescriptional data for post-settlement condition through the internet;
performing the process of personal identifying authentication and the process of confirming the medication information through the connection of the internet when the corresponding patient visits the assigned drugstore and demands the medical preparation according to the prescriptional data, and then performing the preparation and medication and the charge settlement according to whether the pre-settlement is performed, and recording the medicational information of the corresponding patient to the patient database system (DB) through the internet.

6. A method of implementing the electronic prescription as defined in claim 5, wherein the said method further includes the step of implementing the custom advertisement according to the prescriptional drug code and disease code to the assigned doctor and pharmacist when the doctor input the electronic prescription using the hospital terminal and the pharmacist confirms the electronic prescription using the drugstore terminal in the connection of the patient database system, and automatically transferring any one of cash or cyber-point to the account, which is pre-contracted between advertiser, prescription transmitting agent, and hospital-drugstore, as the compensation of consuming the said custom advertisement.

7. A method of constituting the treatment and medical affair record database as defined in claim 1 or 5, wherein the said method includes the mutual authentication between patient and doctor,
the said authentication comprises:
a step which doctor and pharmacist treats and interviews a patient;
a step connecting to the database server after the treatment and receiving the registration authority (doctor) authentication;
a step determining whether the patient certification database of the corresponding treated patient should be registered after the registration authority authentication in the previous step;
a step which doctor makes and registers the patient certificate including personal information and digital signature of the corresponding patient by digital key for registration as a roll of registration authority if the treated patient is not registered in the previous step;
a step which patient makes singular or multiple selection and authenticates family doctor who has authority reading and adding the treatment and medical affair record (including image data);
a step which doctor registers the treatment and medical affair record as family doctor and, if the patient is a registered patient, updates the existing database with the treatment data of the corresponding time; and
a step which family doctor authenticates authority in which cooperative doctor may read the patient record within the range defined in the medical law in case that the cooperative treatment may be needed with the other doctor.

8. A database constituting system for the treatment and medical affair record as defined in claim 7, wherein the said system includes:
terminal (7-11-13) installed in hospital and drugstore;
server (7-10) which provides the said hospital and drugstore terminals with the authentication information of as the registration authority, receives and treats the first treatment and medical affair record or update treatment record inputted from each authenticated hospital and drugstore terminal;
patient certification database system (7-16) which stores and updates the treatment record of each patient handled by the said server; and
pharmacist database system (7-18) and doctor database system (7-17) which are connected with the said server and authenticates the qualification of pharmacist and doctor.
